(19) United States
(12) Patent Application Publication
(10) Pub. No.: US 2021/0009147 A1
(43) Pub. Date: Jan. 14, 2021

(54) METHOD AND DEVICE FOR MONITORING AND/OR DETECTING A SENSOR SYSTEM OF A VEHICLE

(71) Applicant: JENOPTIK ROBOT GMBH, Monheim (DE)

(72) Inventors: Einar MAAG, Solingen (DE); Stefan KIENITZ, Duisburg (DE)

(73) Assignee: JENOPTIK ROBOT GMBH, Monheim (DE)

(21) Appl. No.: 16/982,936

(22) PCT Filed: Mar. 19, 2019
(86) PCT No.: PCT/EP2019/056832

§ 371 Date: Sep. 21, 2020

(30) Foreign Application Priority Data
Mar. 21, 2018 (DE) 10 2018 106 594.9

(51) Int. Cl. B60W 50/04; G01S 13/58; G01S 7/40; G01S 13/931; G01S 17/58; G01S 7/497; G01S 17/931; B60W 50/06; B60W 60/00; B60W 40/04; B64F 5/60

(52) U.S. Cl. CPC B60W 50/045; G01S 13/58; G01S 7/40; G01S 13/931; G01S 17/58; B60W 2554/404; G01S 17/931; B60W 50/06; B60W 60/001; B60W 40/04; B64F 5/60; G01S 7/497

(57) ABSTRACT

A method for monitoring and/or detecting a sensor system of a vehicle comprises a step of identifying a parameter value using a response signal, and a step of determining a monitoring signal that can be allocated to the sensor system, said determination being carried out using the parameter value and a predetermined reaction value.

This nonprovisional is a National Stage of international Application No. PCT/EP2019/056832, which was filed on Mar. 19, 2019, and which claims priority to German Patent Application No. 10 2018 106 594.9, which was filed in Germany on Mar. 21, 2018, and which are both herein incorporated by reference.

### BACKGROUND OF THE INVENTION

Field of the Invention

The present invention relates to a method and to a device for monitoring and/or detecting a sensor system of a vehicle and to an infrastructure system, to a vehicle or to a monitoring vehicle having a corresponding device.

### Description of the Background Art

Vehicles use a sensor system the correct operation of which has to be ensured.

To this end, DE102016000532A1 proposes to calibrate an apparatus of a vehicle, for example a tachometer, using a traffic monitoring device.

### SUMMARY OF THE INVENTION

It is therefore an object of the present invention to provide an improved method and an improved device for monitoring and/or detecting a sensor system of a vehicle and an improved infrastructure system, an improved vehicle and an improved monitoring vehicle according to the independent claims. Advantageous refinements become apparent from the dependent claims and the following description.

A method for monitoring and/or detecting a sensor system of a vehicle comprises the following steps:
calculating a parameter value using a response signal; and
determining a monitoring signal able to be assigned to the sensor system using the parameter value and a predetermined reaction value.

According to various embodiments, the response signal may represent at least one signal emitted by the vehicle or an infrastructure system. The response signal may represent a signal emitted in response to an excitation event concerning the vehicle. Such an excitation event may be temporarily actively triggered, for example by an optical signal, or be continuously present, for example in the form of a curve to be traveled through. The response signal may also represent a signal that is for example emitted continuously when the vehicle is traveling, for example a signal from a surroundings sensor or a communication apparatus of the vehicle.

According to one embodiment, a sensor system of a vehicle may advantageously be monitored and/or detected by evaluating the reaction of the sensor system to an excitation event. In this case, the excitation event may also be triggered by a device arranged externally to the vehicle, such that vehicle-independent monitoring is able to be performed.

According to one embodiment, a method for monitoring and/or detecting a sensor system of a vehicle comprises the following steps:
providing an excitation signal in order to cause an excitation event that triggers a response reaction of the vehicle that involves the sensor system of the vehicle;
calculating a parameter value that represents a recorded value of a parameter of the response reaction using a response signal that represents for example radiation emanating from the vehicle; and
determining a monitoring signal able to be assigned to the sensor system using the parameter value and a predetermined reaction value.

A vehicle may be understood to mean a road vehicle, for example an autonomous, partly autonomous or manually controlled motor vehicle for transporting passengers or loads. As an alternative, it may be an aircraft or a watercraft. The sensor system may comprise at least one sensor apparatus. By way of example, the sensor system may be designed to record surroundings of the vehicle or a state of movement of the vehicle. The sensor system may thus for example comprise a surroundings sensor or a speed-recording sensor. By monitoring and/or detecting the sensor system, it is possible for example to monitor a functionality or a calibration state of the sensor system. The presence of at least one sensor of the sensor system may furthermore be monitored and thus detected.

A response reaction may be understood to mean for example a change of state or action of the vehicle or of an apparatus of the vehicle. The response reaction may thus be a reaction of the sensor system, or a reaction of the vehicle or of an apparatus of the vehicle that is based on sensor data from the sensor system. The sensor system may be involved in the response reaction to the extent that the response reaction is a result of a sensor signal that is provided by the sensor system in response to the excitation event. The excitation event may be selected such that it triggers a foreseeable response reaction. The excitation event may be identified using the sensor system. The excitation event may be made visible or invisible to an occupant of the vehicle and/or the sensor system of the vehicle. The vehicle or the sensor system may comprise a controller that is designed to provide at least one control signal that triggers the response reaction in response to the identification of the excitation event. The response reaction may be identified for example by a device arranged externally to the vehicle, by virtue of the device evaluating the response signal that represents radiation emanating from the vehicle during or after the response reaction. The response reaction may be characterized by the parameter. The parameter may relate for example to a change of state of the vehicle or of an apparatus or of the sensor system of the vehicle. By way of example, the parameter may relate to a speed or change of speed, direction or change of direction of the vehicle or to a characteristic or change in a characteristic of radiation emitted by the vehicle (for example brief illumination of the brake light, changes in the headlight, acoustic feedback). A magnitude of a change of speed of the vehicle, a speed or a measure of a change in light emission from the vehicle or a characteristic of a change in sensor signals that are emitted by the sensor system may for example be identified as parameter value using the response signal. According to one embodiment, in the case of a fully functional sensor system, it may be assumed that the excitation event is followed by a predetermined response reaction that may be characterized by the predetermined reaction value. The predetermined reaction value may be stored as a reference for the parameter value. By comparing the parameter value with the predetermined reaction value, it may thus be concluded whether the sensor system is fully functional or is working within a defined operating tolerance range. The monitoring signal may thus be determined through a suitable combination of the parameter value and of the predetermined reaction value. The monitoring signal may for example indicate a state of the sensor system, or it may also be used to influence the sensor system, for example to calibrate it.

The method and a corresponding device may thus be used for example to calibrate (partly) autonomous vehicles. The method may in this case be used in connection with autonomous vehicles or aircraft that monitor their own sensor system autonomously. The described approach advantageously offers external, independent monitoring of the sensor system. This is advantageous since the question of liability in the event of collisions is crucial in autonomous or semi-autonomous driving. There is liability here for the automobile manufacturers for the automated driving mode and liability for the driver for the manual mode. Using the described approach, information relating to the sensor system may be determined independently of data recorded by the vehicle itself, for example using a tachograph. In this case, monitoring and calibration may advantageously take place externally and independently of the vehicle.

An independent and verified “entity” may thus be implemented as calibration exciter. It is possible to log the sensor responses emanating from the vehicle in the event of an accident or for a technical testing organization. An autonomous solution may in particular be implemented. Connection to a back-office solution for penalizing traffic offenses or for service purposes is in this case also possible. In-situ monitoring may advantageously be implemented. No interface to the vehicle is necessary in this case. The information that is calculated may thus be used even without an interface to the vehicle. It is therefore possible to have a test independent of a vehicle manufacturer of the vehicle and, in addition or as an alternative, calibration of the sensor system of the vehicle. It is in particular possible to provide an independent “third-party” entity for the calibration or calibration excitation of autonomous or semi-autonomous vehicles. A vehicle may also be understood in this case to be an aircraft, a drone, a ship or a rail vehicle.

The described approach may take place in addition or as an alternative to calibration of the sensor system by way of a calibration device in the vehicle, self-calibration by generating a sensor reflection on special test geometries at the road-side or calibration in the workshop. Such calibration may concern for example an assisted high-beam controller or the adaptive cornering light.

According to one embodiment of the described approach, in the determination step, the monitoring signal may thus comprise a calibration value for calibrating the sensor system. A calibration signal comprising the calibration value may be output for example to an interface to the sensor system. As an alternative, the calibration value may be stored for later calibration of the sensor system. In addition or as an alternative, the monitoring signal may be determined such that it indicates a state of the sensor system. Such a monitoring signal may indicate for example that the sensor system is fully functional, has limited functionality or is faulty. By way of example, the monitoring signal may indicate soiling of a sensor of the sensor system or incorrect positioning or alignment of a sensor of the sensor system. The monitoring signal may furthermore indicate presence of the sensor system. It is thereby able to be indicated for example whether a vehicle is equipped with a sensor system suitable for at least partly autonomous driving. By way of example, information contained in the monitoring signal may be displayed on a screen of the vehicle or used to update data, associated with the vehicle, from a traffic control center.

The method may comprise an emission step, in which at least one signal causing the excitation event is emitted using the excitation signal. Such a signal may be an acoustic and/or an electromagnetic signal. A suitable transmission apparatus, for example a light source, may be used to emit such a signal. The excitation event is thereby able to be triggered very quickly and easily. By way of example, in the emission step, a light pulse may be emitted in the direction of the vehicle as the electromagnetic signal. Such a light pulse may for example simulate an oncoming vehicle, such that the response reaction may be a reaction of an adaptive vehicle lighting system of the vehicle. A light curtain or radiation wave curtain appearing in front of the vehicle may also be emitted as the electromagnetic signal. To this end, a laser may for example be actuated accordingly using the excitation signal. An obstacle located in front of the vehicle is thereby able to be simulated, such that the response reaction may be a braking maneuver or a steering maneuver of the vehicle.

The method may comprise a step of performing a change of state, which causes the excitation event, of an object located in the surroundings of the vehicle. The change of state of the object is thereby able to be caused using the excitation signal. The change of state of the object may relate for example to a state of movement or an external appearance of the object. The change of state may in this case be selected such that it is able to be foreseen that the response reaction of the vehicle will be triggered by the change of state. By way of example, in the performance step, a braking procedure and/or another excitation event of a monitoring vehicle located in the surroundings of the vehicle may be performed as the change of state. Such a monitoring vehicle is advantageously not limited to a specific location but rather is able to flow in traffic. It is thus also possible to make a targeted selection of vehicles whose sensor systems are to be monitored. The monitoring vehicle may in this case be located in front of the vehicle or behind the vehicle, for example. If the monitoring vehicle is located behind the vehicle, it is possible to observe for example the tail lights or the braking of the vehicle by way of identifying the brake light, or a tailgating situation.

According to one embodiment, in the calculation step, the parameter value may be calculated as a change of speed, for example a deceleration or acceleration, of the vehicle. A surroundings sensor system of the vehicle is thereby for example able to be monitored, which surroundings sensor system responds when a simulated obstacle in front of the vehicle is selected as excitation event. In addition or as an alternative, the parameter value may be calculated as a characteristic of tracking of an adaptive vehicle lighting system of the vehicle. Such a characteristic may relate for example to a reaction time of the adaptive vehicle lighting system or to an intensity of the light emitted by the vehicle lighting system. A sensor system of the vehicle is thereby for example able to be monitored, which sensor system responds when an oncoming vehicle is captured by a light cone of the vehicle lighting system of the vehicle.

At least said provision, calculation and determination steps of the method may be performed using a device that may be arranged for example in the vehicle itself, in an infrastructure system, in particular a traffic monitoring system, or in a monitoring vehicle. If the device is arranged in an infrastructure system or a monitoring vehicle, then the sensor system of the vehicle may be monitored by an entity independent of the vehicle.

The method may comprise a step of recording the response signal. In this case, the radiation represented by the response signal and emanating from the vehicle may represent radiation emitted and/or reflected by the vehicle. The emitted radiation may be for example electromagnetic or acoustic radiation emitted by a surroundings-recording sensor system of the vehicle for recording the surroundings. The emitted radiation may also be light that is emitted by a vehicle lighting system of the vehicle. The reflected radiation may be for example reflected ambient light or reflected sensor radiation emitted by a sensor apparatus of a device for performing the method. By recording such radiation as a response signal, it is possible for example to record a change of speed or a change in the light emitted by a vehicle lighting system of the vehicle.

The method may comprise a step of identifying a type of the vehicle. The type of the vehicle may be used in a selection step in order to select the reaction value. This is advantageous since an excitation event may trigger different response reactions in different vehicle types. Such different response reactions may be characterized by different reaction values.

The response signal may represent emitted sensor signals from the sensor system, and the parameter value may represent an intensity distribution of the emitted sensor signals. The parameter value may thereby represent a measurement map.

In this case, in the determination step, the parameter value and the predetermined reaction value may be used to determine presence or absence of a sensor, required for at least partly autonomous driving, of the sensor system. The monitoring signal may indicate a degree of autonomous driving of the vehicle depending on the presence or absence of the required sensor. It is thereby possible to establish for example that a vehicle capable of autonomous driving per se is being controlled manually, for example because a sensor, required for autonomous driving, of the sensor system has failed.

A device for monitoring a sensor system of a vehicle has the following features:

Optionally a provision apparatus that is designed to provide an excitation signal in order to cause an excitation event that triggers a response reaction of the vehicle that involves the sensor system of the vehicle;
a calculation apparatus that is designed to calculate a parameter value that for example represents a recorded value of a parameter of the response reaction using a response signal that represents for example radiation emanating from the vehicle; and
a determination apparatus that is designed to determine a monitoring signal able to be assigned to the sensor system using the parameter value and a predetermined reaction value.

The steps described in connection with said method may thus advantageously be implemented using suitable apparatuses of a device for monitoring the sensor system of a vehicle. According to various embodiments, the device may be arranged completely inside the vehicle or may be arranged completely externally to the vehicle. This makes it possible to implement an infrastructure system, a vehicle, for example a road vehicle, land vehicle or aircraft, or a monitoring vehicle, each of which may comprise a corresponding device or is coupled to such a device. An infrastructure system may be understood to mean for example a traffic monitoring device, for example for measuring speed or measuring distance, a traffic light system or a traffic control system. A monitoring vehicle may be understood to mean for example a road vehicle or an aircraft, such as for example a drone, or a watercraft.

A device may in this case be understood to mean an electrical device that processes sensor signals and outputs control and/or data signals on the basis thereof. The device may have an interface that may be designed in the form of hardware and/or software. In the case of a hardware-based design, the interfaces may for example be part of what is known as a system ASIC, which contains an extremely wide variety of functions of the device. It is however also possible for the interfaces to be separate, integrated circuits or to at least partially consist of discrete components. In the case of a software-based design, the interfaces may be software modules that are present for example on a microcontroller alongside other software modules.

Also advantageous is a computer program product containing program code that is able to be stored on a machine-readable carrier such as a semiconductor memory, a hard disk memory or an optical memory and is used to perform the method according to one of the embodiments described above when the program product is executed on a computer or a device.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus, are not limitive of the present invention, and wherein:

FIG. 1 shows a schematic illustration of an excitation event for monitoring a sensor system of a vehicle according to one exemplary embodiment;

FIG. 2 shows a schematic illustration of an excitation event for monitoring a sensor system of a vehicle according to one exemplary embodiment;

FIG. 3 shows a schematic illustration of a device for monitoring a sensor system of a vehicle according to one exemplary embodiment; and

FIG. 4 shows a flowchart of a method for monitoring a sensor system of a vehicle according to one exemplary embodiment.

### DETAILED DESCRIPTION

In the following description of preferred exemplary embodiments of the present invention, the same or similar reference signs are used for the elements that are illustrated in the different figures and have a similar effect, wherein a repeated description of these elements is omitted.

FIG. 1 shows a schematic illustration of a vehicle 100 during an excitation event 102 according to one exemplary embodiment. The vehicle 100 is for example a road vehicle that is traveling on a road. According to this exemplary embodiment, the excitation event 102 constitutes a light curtain that represents an obstacle located in front of the vehicle 100. The vehicle 100 has a sensor system 104 that comprises at least one sensor, according to this exemplary embodiment a plurality of sensors. According to this exemplary embodiment, at least one sensor of the sensor system 104 is embodied as a surroundings sensor, for example as a camera, and is designed to identify the light curtain and to interpret it as an obstacle. Further sensors of the sensor system 104 comprise for example an ultrasound sensor or a radar sensor, a photodiode or a speed measurement sensor.

According to one exemplary embodiment, the vehicle 100 has a controller that is designed to initiate a response reaction in response to the identification of the obstacle simulated by the excitation event 102. The controller may be embodied as a separate controller or be integrated into the sensor system 104. According to this exemplary embodiment, the response reaction consists in the vehicle 100 braking. The excitation event 102 is selected such that the response reaction of the vehicle 100 is able to be foreseen and thus compared with an expected response reaction. To this end, for example, parameters characterizing the actual and the expected response reaction, for example physical variables, may be compared with one another.

According to this exemplary embodiment, the causing of the excitation event 102 is controlled by a device 110. According to this exemplary embodiment, the device 110 is integrated into an infrastructure system 112, here a traffic monitoring infrastructure system, for example what is known as a “traffic tower”. The infrastructure system 112 has a transmission apparatus 114 that is designed to emit a signal 116 causing the excitation event 102 in response to an excitation signal provided by the device 110. According to this exemplary embodiment, the transmission apparatus 114 is embodied as a laser that is designed to emit the signal 116 in the form of laser beams that form the light curtain in front of the vehicle 100. In addition or as an alternative, the transmission apparatus 114 may emit for example ultrasound beams, radar beams or radio waves, which are recorded by the sensor system 104 of the vehicle 100 and may thus serve as excitation event 102.

The infrastructure system 112 furthermore has a reception apparatus 118 that is designed to receive radiation 120 emanating from the vehicle 100 and to provide a response signal, representing the radiation 120, to the device 110. According to various exemplary embodiments, the radiation 120 is electromagnetic or acoustic radiation emitted or reflected by the vehicle 100. According to this exemplary embodiment, the radiation 120 that is received by the reception apparatus 118 is suitable for recording a change of speed of the vehicle 100.

According to this exemplary embodiment, the device 110 is designed to determine a magnitude of a change of speed of the vehicle 100 using the response signal provided by the reception apparatus 118. The change of speed represents a parameter of the response reaction of the vehicle 100 to the excitation event 102. The magnitude of the change of speed represents a parameter value of the parameter. Since the excitation event 102 was initiated by the device 110, the response reaction of the vehicle 100 is to be expected. The expected response reaction of the vehicle 100 may in this case be characterized by a predetermined reaction value, which may be stored in the device 110 or may be read in by the device 110. In order to determine whether the actual response reaction of the vehicle 100 matches the expected response reaction, the device 110 is designed, according to one exemplary embodiment, to compare the parameter value, here the magnitude of the change of speed of the vehicle 100, with the predetermined reaction value. If there is a discrepancy between the parameter value and the predetermined reaction value, then this is considered, according to one exemplary embodiment, to be an indication that the excitation event was not correctly identified by the sensor system 104 of the vehicle 100. If the parameter value and the predetermined reaction value correspond to one another, then, according to one exemplary embodiment, it is assumed that the sensor system 104 of the vehicle 100 is fully functional.

According to one exemplary embodiment, the device 110 is designed to use the parameter value and the predetermined reaction value to provide a monitoring signal that is designed to indicate the state of the sensor system 104 or that comprises a calibration value that is suitable for calibrating the sensor system 104. The monitoring signal is transmitted to the vehicle 100, for example via a radio interface of the device 110 or of the infrastructure apparatus 112, such that for example the calibration value may be used to calibrate the sensor system 104 while the vehicle 100 is traveling past the infrastructure apparatus 112.

According to one exemplary embodiment, the vehicle 100 has an adaptive lighting system 130. The adaptive lighting system 130 is designed to avoid dazzling an oncoming vehicle. To this end, the adaptive lighting system 130 is designed to change a characteristic of light emission from the adaptive lighting system 130. To this end, the adaptive lighting system 130 is designed for example to adapt an intensity or a light distribution of the light emission. In order to identify an oncoming vehicle that could possibly be dazzled, according to one exemplary embodiment, the vehicle 100 uses the sensor system 104. According to one exemplary embodiment, the device 110 is additionally or alternatively used to monitor the sensor system 104 as to whether an oncoming vehicle is identified. To this end, the device 110 is designed to actuate the transmission apparatus 114 or a further transmission apparatus such that the signal 116 is emitted in the form of a light pulse that simulates an oncoming vehicle from the point of view of the vehicle 100. When the sensor system 104 is fully functional, the light pulse is considered by the sensor system 104 to be an excitation event 102 that is assessed as an oncoming vehicle. In this case, a signal provided by the sensor system 104 is used to suitably change the characteristic of the light emission from the adaptive lighting system 130. The change in the characteristic of the light emission may thus be considered to be a response reaction to the excitation event 102. The reception apparatus 118 or a further reception apparatus is designed to receive light emitted by the adaptive lighting system 130 as the radiation 120 and to provide a response signal, representing the radiation 120, to the device 110. The device 110 is designed to use the response signal to calculate a parameter value representing the change in the characteristic of the light emission and to compare it with a predetermined reaction value. The device 110 is thereby designed to check at least that part of the sensor system 104 that is used to identify an oncoming vehicle.

According to various exemplary embodiments, the transmission apparatus 114 and/or the reception apparatus 118 may also be considered to be part of the device 110, or the device may be integrated into the transmission apparatus 114 and/or the reception apparatus 118. The transmission apparatus 114 and the reception apparatus 118 may also be embodied as a unit. In order to calculate the response reaction of the vehicle 100, the reception apparatus 118 may also be embodied as a transceiver apparatus and designed to emit a measurement signal and to receive a signal reflected from the vehicle 100 as the radiation 120. This makes it possible for example to exactly record the speed of the vehicle 100.

According to one exemplary embodiment, the calibration or excitation method and device 110 described here are used to externally calibrate different sensors of the sensor system 104 of the for example autonomous vehicle 100. According to one alternative exemplary embodiment, the device 110 is arranged as a box in the vehicle 100. The device 110 may be embodied as desired and, according to this exemplary embodiment, mention is made of the refinement of the infrastructure system 112, also called “traffic tower” below. The infrastructure system 112 takes responsibility for the process safety of the autonomous driving and calibrates or excites the calibration of the sensors of passing automobiles, such as for example the sensor system 104 of the vehicle 100.

The described approach may be performed in situ. The device 110 or, according to this exemplary embodiment, the infrastructure system 112 comprising the device 110 excites defined responses. According to one exemplary embodiment, the infrastructure system 112 simulates an in-situ blockade, for example an obstacle, as excitation event 102, for example by way of a laser curtain, and measures responses and/or delays of the vehicles, here of the vehicle 100. According to one exemplary embodiment, the infrastructure system 112 draws a “measurement map” with the intensity distribution of the emitted sensor signals from the sensor system 104, for example radar, IR, WLAN—everything that emits from the vehicle 100—as an example of the radiation 120 and evaluates it. The radiation 120 may be evaluated depending in particular on the vehicle type. According to one exemplary embodiment, it is additionally established what degree of autonomous driving is present, for example fully autonomous, partly autonomous and manually without sensors in the case of an older vehicle 100. According to one exemplary embodiment, the infrastructure system 112 is designed to measure a displacement of the sensors of the sensor system 104. To this end, according to one exemplary embodiment, the radiation 120 received by the reception apparatus 118 is evaluated. A corresponding displacement of the sensors results for example from sheet metal damage in areas between the sensors. Such a displacement is able to be identified by monitoring the sensor system 104. The displacement may be identified for example in that a characteristic of the radiation 120 does not match an expected characteristic. Identifying the displacement is advantageous since the displacement is able to be identified immediately and it is not necessary to wait until the next general servicing of the vehicle 100. The infrastructure system 112 logs abnormalities and/or soiling of sensors of the sensor system 104. According to one exemplary embodiment, the device 110 is designed to identify corresponding abnormalities and/or soiling by evaluating the response signal provided by the reception apparatus 118 and to indicate them using the monitoring signal.

According to the exemplary embodiment shown, the infrastructure system 102 is embodied as a fixedly installed, stationary object. According to one alternative exemplary embodiment, the infrastructure system 102 is itself an autonomous vehicle or a drone. The infrastructure system 102 is thereby able for example to perform or simulate targeted test braking operations in the millisecond range and thereby log/diagnose distances and speeds and, based on these data, calibrate the vehicles 100 from the surroundings in situ, etc.

A data exchange is in particular possible through one or more vehicle sensor calibration interfaces to the vehicles, and it is thus possible to provide an interface in order to emit the monitoring signal provided by the device 110 or data contained in the monitoring signal to the vehicle 100 in order to calibrate the sensor system 104 using the monitoring signal or corresponding data.

One embodiment of calibration excitations is that of monitoring and tracking the adaptive vehicle lighting system 130. This primarily concerns the correct operation of a high-beam assistant in order to avoid dazzling drivers of vehicles ahead and in particular oncoming vehicles. This method is also applicable to cornering lights or comparable lighting systems.

One particular embodiment of the calibration excitation caused by the excitation event 102 may be achieved for example using (radio) waves, acoustically, optically, in particular using light pulses or a light curtain.

It is advantageously possible to combine the device with known traffic monitoring measurement technology (for example speed monitoring, red light monitoring, toll monitoring—all methods including automatic number plate recognition (ANPR) including video recordings with facial recognition of the occupants), as is already present for example in the infrastructure system 102.

The described approach is described in more detail with reference to an exemplary embodiment on the basis of FIG. 1. The device 110 that performs a corresponding method is in this case combined with an infrastructure system 102, here in the form of the “traffic tower” having various sensors, here by way of example a transmission apparatus 114 in the form of a laser for emitting signals 116 in the form of laser radiation in order to generate an “invisible” laser curtain as excitation event 102, which creates a blockade for fractions of a second. The vehicle 100 is equipped with the sensor system 104 having sensors of an extremely wide variety of types. The reception apparatus 118, for example in the form of a sensor in the infrastructure system 102 embodied as a tower, measures stretches/distances x and delays or changes Ax/At in response to sensor reactions of the sensor system 104, triggered by the excitation event 102 in the form of the laser curtain.

According to one exemplary embodiment, the excitation event 102 is not actively triggered but is caused for example by the occurrence of a curve in the profile of the road or a traffic sign or another infrastructure object. Such an excitation event also leads to a foreseeable response reaction, which may be analyzed using the response signal 120.

According to one exemplary embodiment, the response signal 120 is additionally or alternatively provided by an infrastructure system, for example a loop recessed into the roadway, for recording the vehicle 100 or a state of the vehicle 100.

According to one exemplary embodiment, the response signal 120 is emitted sensor signals from the sensor system 104 and the parameter value represents an intensity distribution of the emitted sensor signals. The predetermined reaction value in this case represents an expected intensity distribution that is stored for example specifically for the type of the vehicle 100 or of the sensor system 104. By evaluating the intensity distribution, it is thereby possible to conclude as to the presence or absence of a sensor, required for at least partly autonomous driving of the vehicle 100, of the sensor system 104. To this end, a discrepancy between the actual intensity distribution and the expected intensity distribution may in particular be evaluated. Advantageously, with knowledge of the presence or absence of the sensor required for at least partly autonomous driving of the vehicle 100 or directly from the intensity distribution or directly from a comparison of the intensity distribution with the expected intensity distribution, it is possible to conclude as to a degree of autonomous driving of the vehicle 100 and indicate this using the monitoring signal.

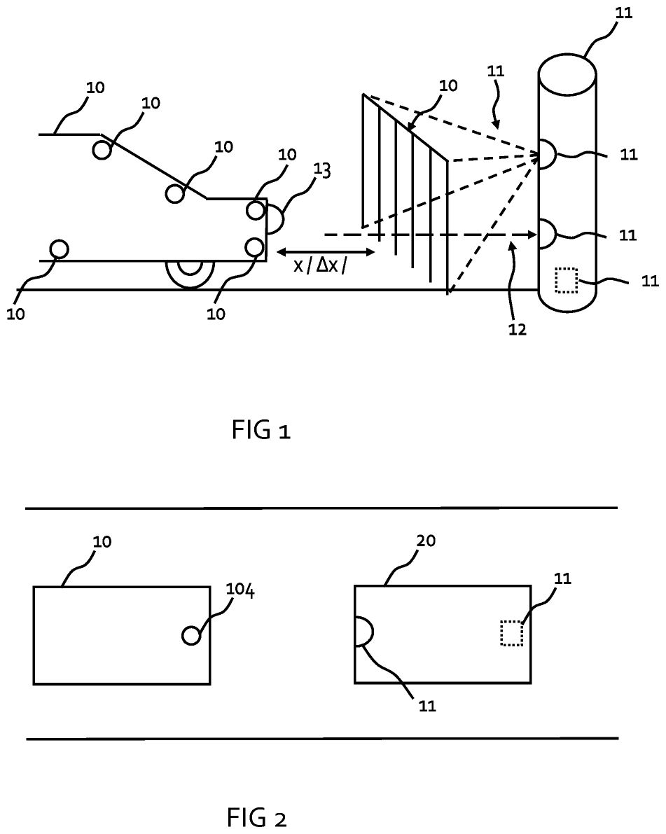

FIG. 2 shows a schematic illustration of an excitation event for monitoring a sensor system of a vehicle 100 according to one exemplary embodiment. According to this exemplary embodiment, the device 110 for monitoring the sensor system 104 of the vehicle 100 is arranged in a monitoring vehicle 200. The vehicle 100 and the monitoring vehicle 200 are traveling on a road, wherein the monitoring vehicle 200 is traveling in front of the vehicle 100. The monitoring vehicle 200 is designed to perform or to simulate a braking procedure as excitation event, for example by activating the brake lights. The sensor system 104 of the vehicle 100 is designed to identify the braking procedure. A sensor signal provided by the sensor system 104 is used by the vehicle 100 in order for example likewise to perform a braking procedure or to initiate an evasive maneuver as response reaction to the braking procedure. The monitoring vehicle 200 is designed to identify the response reaction, for example using a reception apparatus 118. To this end, the reception apparatus 118 records for example a distance from the vehicle 100 or a speed of the vehicle 100. The device 110 is designed to compare the actual response reaction of the vehicle 100 with the response reaction to be expected with regard to the excitation event. To this end, the device 110 is designed for example to compare at least one parameter value characterizing the actual response reaction with a predetermined reaction value characterizing the expected response reaction.

According to one exemplary embodiment, the device 110 is designed to identify a type of the vehicle 100 and to use a predetermined reaction value assigned to the type to evaluate the actual response reaction.

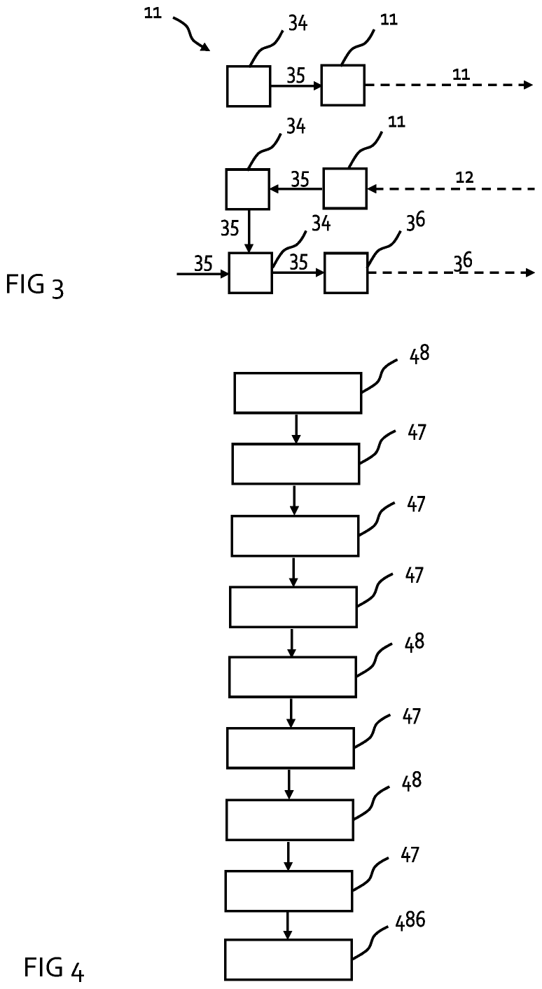

FIG. 3 shows a schematic illustration of a device 110 for monitoring a sensor system of a vehicle according to one exemplary embodiment. This may be a device 110 that may be integrated for example into a monitoring vehicle or an infrastructure system or into the vehicle whose sensor system is intended to be monitored.

The device 110 optionally has a provision apparatus 340, a calculation apparatus 342 and a determination apparatus 344. The provision apparatus 340 is designed, at the beginning of a monitoring procedure, to provide an excitation signal 350 that, according to this exemplary embodiment, is suitable for actuating a transmission apparatus 114 such that the transmission apparatus 114 emits a signal 116 that causes an excitation event able to be sensed by the sensor system of the vehicle. The excitation event is in this case designed such that it triggers an expectable response reaction of the vehicle.

A reception apparatus 118 is designed to receive radiation 120 emanating from the vehicle or an infrastructure apparatus, or generally a response, and to provide a response signal 352, representing the radiation 120, to the calculation apparatus 342. The response reaction of the vehicle is able to be identified and analyzed by suitably evaluating the radiation 120. The calculation apparatus 342 is designed to use the response signal 352 to calculate a parameter value 354 that represents a recorded value of a parameter of the response reaction. According to this exemplary embodiment, the determination apparatus 344 is designed to use the parameter value 354 and a predetermined reaction value 356, for example to combine or to compare them with one another, in order to determine a monitoring signal 358 able to be assigned to the sensor system. According to one exemplary embodiment, the determination apparatus 344 is designed to select the predetermined reaction value 356 as a value that is matched to the type of excitation event and/or the type of the vehicle and thus to the expected response reaction of the vehicle and/or of the sensor system to be monitored.

According to this exemplary embodiment, a transmission apparatus 360 is designed to transmit monitoring information contained in the monitoring signal 358, according to this exemplary embodiment a calibration value 362, to the sensor system via an interface. The sensor system may be designed to use the calibration value 362 for calibration.

According to one exemplary embodiment, the device 110 comprises at least one of the apparatuses 114, 118, 360.

FIG. 4 shows a flowchart of a method for monitoring a sensor system of a vehicle according to one exemplary embodiment. The method may be performed for example using a device described with reference to the previous figures.

The method comprises at least a step 470 of providing an excitation signal for causing an excitation event, a step 472 of calculating a parameter value using a response signal and a step 474 of determining a monitoring signal able to be assigned to the sensor system using the parameter value and a predetermined reaction value.

According to one exemplary embodiment, the method optionally comprises a step 476 in which at least one signal causing the excitation event is emitted using the excitation signal provided in step 470. In addition or as an alternative to step 476, a step 478 is optionally performed in which a change of state of an object located in the surroundings of the vehicle is performed using the excitation signal, wherein the excitation event is caused by the change of state. In one particular embodiment, the object located in the surroundings of the vehicle represents a test field or a suitable curve profile, which in particular diagnoses the suitability for traffic lane maintenance and/or adaptive headlight tracking (not shown).

The method optionally comprises a step 480 in which the response signal is recorded, which may then be used further in step 472 to evaluate the response reaction of the vehicle. The method likewise optionally comprises a step 482 in which a type of the vehicle is identified and a step 484 in which the predetermined reaction value is selected using the type and is used in step 474 of determining the monitoring signal. By way of example, step 482 is performed at the beginning of the method, such that, in step 470, an excitation signal tailored to the type of the vehicle and thus an excitation event tailored to the type of the vehicle is able to be caused.

The method optionally furthermore comprises a step 486, in which the calibration value contained in the monitoring signal for calibrating the sensor system is emitted to an interface to the sensor system, for example via a radio interface.

According to one exemplary embodiment, the method does not comprise provision step 470. The parameter value may also be calculated using the response signal in calculation step 472, wherein the response signal may also represent for example a signal emitted by an infrastructure apparatus or sensor signals from the sensor system.

If an exemplary embodiment comprises an “and/or” link between a first feature and a second feature, then this may be interpreted such that the exemplary embodiment contains both the first feature and the second feature in accordance with one embodiment and either only the first feature or only the second feature in accordance with a further embodiment.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for monitoring and/or detecting a sensor system of a vehicle, wherein the method comprises the following steps:
calculating a parameter value using a response signal; and
determining a monitoring signal able to be assigned to the sensor system using the parameter value and a predetermined reaction value.

2. The method as claimed in claim 1, in which, in the determination step, the monitoring signal comprises a calibration value for calibrating the sensor system and/or indicates a state of the sensor system and/or presence of the sensor system.

3. The method as claimed in claim 1, having a step of providing an excitation signal in order to cause an excitation event that triggers a response reaction of the vehicle that involves the sensor system of the vehicle, wherein the parameter value represents a recorded value of a parameter of the response reaction.

4. The method as claimed in claim 3, having a step of emitting at least one acoustic and/or electromagnetic signal causing the excitation event using the excitation signal.

5. The method as claimed in claim 4, in which, in the emission step, a light pulse is emitted in the direction of the vehicle or a light or radiation wave curtain appearing in front of the vehicle is emitted as the signal.

6. The method as claimed in claim 3, having a step of performing a change of state, which causes the excitation event of an object located in the surroundings of the vehicle using the excitation signal.

7. The method as claimed in claim 6, in which, in the performance step, a braking procedure and/or another excitation event of an object in the form of a monitoring vehicle located in the surroundings of the vehicle is performed as the change of state.

8. The method as claimed in claim 1, in which, in the calculation step, the parameter value is calculated as a change of speed of the vehicle or as a characteristic of tracking of an adaptive vehicle lighting system of the vehicle.

9. The method as claimed in claim 1, in which at least the provision, calculation and determination steps are performed using a device able to be arranged in the vehicle, in an infrastructure system, in particular a traffic monitoring system, or in a monitoring vehicle.

10. The method as claimed in claim 1, in which the response signal represents radiation emanating from the vehicle and the method comprises a step of recording the response signal, wherein the radiation emanating from the vehicle represents radiation emitted and/or reflected by the vehicle.

11. The method as claimed in claim 1, having a step of identifying a type of the vehicle and a step of selecting the reaction value using the type.

12. The method as claimed in claim 1, in which the response signal represents emitted sensor signals from the sensor system and the parameter value represents an intensity distribution of the emitted sensor signals.

13. The method as claimed in claim 12, in which, in the determination step, presence or absence of a sensor, required for at least partly autonomous driving, of the sensor system is determined using the parameter value and the predetermined reaction value, and the monitoring signal indicates a degree of autonomous driving of the vehicle depending on the presence or absence of the required sensor.

14. A device for monitoring a sensor system of a vehicle, wherein the device has the following features:
a calculation apparatus that is designed to calculate a parameter value using a response signal; and
a determination apparatus that is designed to determine a monitoring signal able to be assigned to the sensor system using the parameter value and a predetermined reaction value.

15. An infrastructure system, vehicle, aircraft, watercraft or monitoring vehicle having a device as claimed in claim 14.
